(19) United States
(12) Patent Application Publication
(10) Pub. No.: US 2012/0250510 A1
(43) Pub. Date: Oct. 4, 2012

(54) Information Processing Apparatus and Communication Controlling Method

(76) Inventor: Jingsha He, Tokyo (CN)

(21) Appl. No.: 13/283,343

(22) Filed: Oct. 27, 2011

(30) Foreign Application Priority Data
Mar. 31, 2011 (JP) 2011-080104

(51) Int. Cl. H04W 16/08; H04W 52/04; H04W 28/08; H04L 12/26; H04W 24/00

(52) U.S. Cl. 370/235

(57) ABSTRACT

An information processing apparatus according to an embodiment includes a wireless communication module including a first wireless communication section that supports a first wireless communication system and a second wireless communication section that supports a second wireless communication system having a working frequency band in conflict with a working frequency band of the first wireless communication system, a traffic detecting section configured to calculate traffic of communication based on the first wireless communication system by the first wireless communication section, a traffic determining section configured to determine whether the traffic is less than a predetermined threshold value, and a control section configured to cause performance of an access point search for the second wireless communication system during a period when the traffic is less than the predetermined threshold value, on the basis of a result of the determination by the traffic determining section.

### CROSS-REFERENCE TO RELATED APPLICATION

This application is based upon and claims the benefit of priority from the prior Japanese Patent Application No. 2011-80104 filed on Mar. 31, 2011; the entire contents of which are incorporated herein by reference.

### FIELD

An embodiment of the present invention described herein relates generally to an information processing apparatus and a communication controlling method.

### BACKGROUND

Various types of data communication services have been popular. For example, use of wireless networks for cellular phones, PHS phones, and the like allows use of data communication services in a wide range of regions such as at home and outside the home and connection to the Internet. WiMAX (Worldwide Interoperability for Microwave Access) also has recently been used as a data communication service which is a wide-area service and whose communication speed is relatively high. Use of each of the data communication services in an information processing apparatus requires a data communication module supporting the data communication service.

Methods for connecting an information processing apparatus to the Internet include connection to a router connected to the Internet via a wireless access point. An information processing apparatus equipped with a data communication module capable of data communication based on a wireless LAN (Local Area Network) is commercialized in order to allow connection to a wireless access point. A communication module with both a communication function for WiMAX and a communication function for a wireless LAN is also commercialized.

A data communication service using WiMAX may require a high communication charge. In terms of communication charges and communication speed, use of a data communication service via a wireless LAN is generally more advantageous. However, a wireless LAN can be used only near a wireless access point. One conceivable method for coping with this is to perform switching so as to use WiMAX outside available wireless LAN areas and to use a wireless LAN in an available wireless LAN area.

Since a working frequency band of WiMAX and a working frequency band of a wireless LAN conflict with each other, any one of WiMAX and a wireless LAN is exclusively used at present, and both are not simultaneously used. It is preferable to perform a wireless LAN access point search to determine whether a wireless LAN is available even during use of WiMAX and switch to a wireless LAN, because a wireless LAN environment can be implemented at lower cost than WiMAX.

If an access point search for detecting an available wireless LAN area is performed to automatically perform switching between wireless communication networks as described above, interference of a search signal adversely affects WiMAX communication being used. Additionally, a data communication module for WiMAX and a data communication module for a wireless LAN both operate during a search period, which increases power consumption.

### BRIEF DESCRIPTION OF THE DRAWINGS

FIG. 1 is a block diagram showing an information processing apparatus according to an embodiment of the present invention;

FIGS. 2A and 2B are timing charts for explaining a search instruction signal; and

FIG. 3 is a flow chart showing an operation flow according to the embodiment.

### DETAILED DESCRIPTION

An information processing apparatus according to an embodiment includes a wireless communication module including a first wireless communication section that supports a first wireless communication system and a second wireless communication section that supports a second wireless communication system having a working frequency band in conflict with a working frequency band of the first wireless communication system, a traffic detecting section configured to calculate traffic of communication based on the first wireless communication system by the first wireless communication section, a traffic determining section configured to determine whether the traffic is less than a predetermined threshold value, and a control section configured to cause performance of an access point search for the second wireless communication system during a period when the traffic is less than the predetermined threshold value, on the basis of a result of the determination by the traffic determining section.

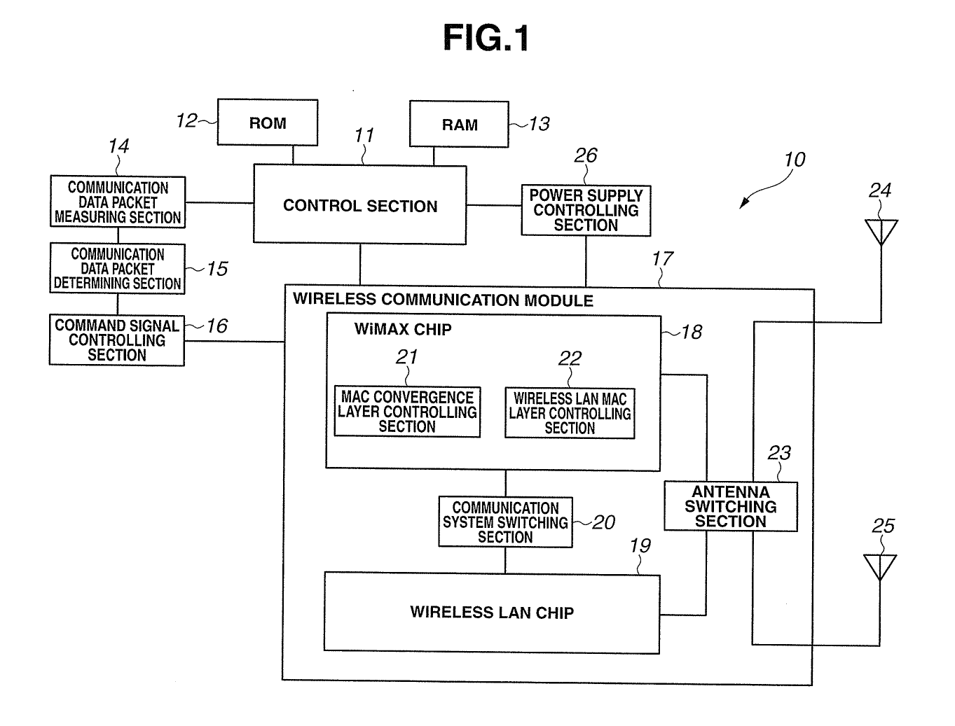

The embodiment of the present invention will be described in detail below with reference to the drawings. FIG. 1 is a block diagram showing the information processing apparatus according to the embodiment of the present invention.

An information processing apparatus 10 shown in FIG. 1 includes a wireless communication module 17. The wireless communication module 17 is equipped with a WiMAX chip 18 and a wireless LAN chip 19. The WiMAX chip 18 of the wireless communication module 17 is configured to be capable of WiMAX-based communication under control of a control section 11. The wireless LAN chip 19 is configured to be capable of wireless LAN-based communication under control of the control section 11.

A piece of driver software for driving the WiMAX chip 18 and the wireless LAN chip 19 of the wireless communication module 17 is stored in an external storage device (not shown). The control section 11 drives and controls the chips 18 and 19 of the wireless communication module by reading and executing the piece of driver software. Note that a RAM 13 is working memory and that a program used by the control section 11 is stored in a ROM 12.

The wireless LAN chip 19 has all functions for wireless LAN communication. The wireless LAN chip 19 is connected to antennas 24 and 25 via an antenna switching section 23. When the wireless LAN chip 19 receives a high-frequency signal induced at the antenna 24, the wireless LAN chip 19 performs processing, such as demodulation processing, required to receive a wireless LAN packet and supplies the received data to the control section 11. The wireless LAN chip 19 performs processing of the data supplied from the control section 11, such as modulation processing, required to generate a wireless LAN packet and supplies the generated high-frequency signal to the antennas 24 and 25 via the antenna switching section 23.

If there is an access point (not shown) within an effective wireless range of the wireless LAN chip 19, the wireless LAN chip 19 can perform data communication via the access point under control of the control section 11. The wireless LAN chip 19 establishes a radio link with an access point by receiving a beacon frame from the access point.

As described above, the wireless LAN chip 19 is controlled on the basis of the piece of driver software by the control section 11 to perform processing at a physical layer and processing at a MAC (Media Access Control) layer.

The wireless LAN chip 19 transmits and receives data to and from the access point after the radio link is set and receives a provided data communication service via the access point.

The WiMAX chip 18 has all functions for WiMAX communication. Of the functions, only a MAC convergence layer controlling section 21 configured to control a MAC convergence layer is shown in FIG. 1. The WiMAX chip 18 implements a standard MAC layer function with the MAC convergence layer controlling section 21, thereby being provided with an interface to a physical layer which is media-independent.

Communication for establishing a communication link is also necessary before actual data transmission in WiMAX communication. More specifically, the MAC convergence layer controlling section 21 of the WiMAX chip 18 first receives a preamble signal from a base station and establishes synchronization. After adjustment required for communication such as ID setting, the MAC convergence layer controlling section 21 performs authentication, exchanges cryptographic keys, registers an operation mode, and establishes a communication channel.

A physical layer controlling section (not shown) of the WiMAX chip 18 can perform communication based on OFDM modulation, as in the wireless LAN physical layer. When the communication channel is established, the WiMAX chip 18 transmits and receives data to and from the base station via the antennas 24 and 25.

In the present embodiment, the WiMAX chip 18 includes a wireless LAN MAC layer controlling section 22. The wireless LAN MAC layer controlling section 22 implements a function of the MAC layer of the wireless LAN chip 19. As described above, a physical layer of the WiMAX chip 18 has a same configuration as the physical layer of the wireless LAN chip 19, and can exchange information for an access point search with a wireless LAN access point. The wireless LAN MAC layer controlling section 22 sets a radio link with an access point using a function of the physical layer provided at the WiMAX chip 18 under control of the control section 11.

More specifically, the wireless LAN MAC layer controlling section 22 holds an SSID (Service Set Identification) required for wireless LAN-based communication and beacon frame information. An access point with which the wireless communication module 17 can communicate manages an SSID of the wireless communication module 17 and transmits a beacon frame at fixed intervals.

The wireless LAN MAC layer controlling section 22 performs an access point search in accordance with a search instruction signal (to be described later) and detects a beacon generated by an access point. The wireless LAN MAC layer controlling section 22 detects a beacon frequency (a channel) and issues an authentication request to an access point using the detected frequency and the SSID set in advance. If the access point manages a same SSID as the SSID, the access point transmits an authentication response. When the wireless LAN MAC layer controlling section 22 receives the authentication response, the wireless LAN MAC layer controlling section 22 issues a connection request. Upon receipt of permission for connection from the access point, a radio link with the access point is established.

Note that the control of the MAX layer to be performed by the wireless LAN MAC layer controlling section 22 is also performed by a MAC layer controlling section (not shown) of the wireless LAN chip 19.

In the present embodiment, the wireless LAN MAC layer controlling section 22 of the WiMAX chip 18 is configured to perform an access point search when a radio link established by the WiMAX chip 18 is maintained. A result of measurement by a communication data packet measuring section 14 is used for control of the search.

The communication data packet measuring section 14 measures the number of data packets being communicated by the WiMAX chip 18 on the basis of information from the control section 11. Note that the number of communication packets can also be calculated by a known command executed by the control section 11.

A result of measurement by the communication data packet measuring section 14 is given to a communication data packet determining section 15. The communication data packet determining section 15 determines whether the amount of communication data is more than or less than a predetermined threshold value by comparing the number of data packets being communicated with the threshold value and outputs a result of the determination to a command signal controlling section 16.

If the result of the determination by the communication data packet determining section 15 shows that the amount of data communicated by the WiMAX chip 18 is less than the threshold value, the command signal controlling section 16 controls the wireless LAN MAC layer controlling section 22 with a search instruction signal so as to perform an access point search. On the other hand, if the result of the determination by the communication data packet determining section 15 shows that the amount of data communicated by the WiMAX chip 18 is not less than the threshold value, the command signal controlling section 16 is configured to inhibit an access point search by the wireless LAN MAC layer controlling section 22.

In other words, if the WiMAX chip 18 is required to have high communication performance, the command signal controlling section 16 inhibits a wireless LAN access point search. A wireless LAN access point search is performed only when the WiMAX chip 18 is required to have relatively low communication performance.

A result of the search by the wireless LAN MAC layer controlling section 22 is supplied to the control section 11. A communication system switching section 20 is configured to be controlled by the control section 11 so as to switch a communication system to wireless LAN-based communication when a wireless LAN access point is detected during data communication by the WiMAX chip 18.

A power supply controlling section 26 is configured to supply power only to any one of the WiMAX chip 18 and the wireless LAN chip 19 under control of the control section 11. When normal data communication is performed by the WiMAX chip 18, the antenna switching section 23 connects two antenna ports (not shown) of the WiMAX chip 18 to the antennas 24 and 25, respectively. When normal data communication is performed by the wireless LAN chip 19, the antenna switching section 23 connects two antenna ports (not shown) of the wireless LAN chip 19 to the antennas 24 and 25, respectively. The antenna switching section 23 is configured to connect an antenna port for WiMAX communication of the WiMAX chip 18 to the antenna 24 and connect an antenna port for access point search of the WiMAX chip 18 to the antenna 25 under control of the control section 11 when WiMAX-based wireless communication and a wireless LAN access point search are performed by the WiMAX chip 18.

The antennas are switched to used for WiMAX communication and for access point search, and mutual interference between WiMAX communication and access point search can be suppressed.

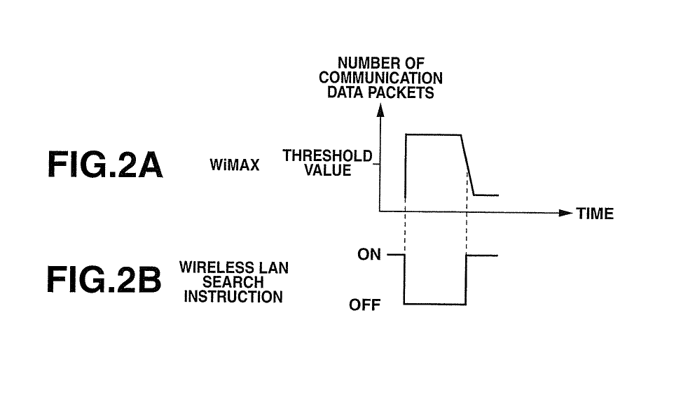

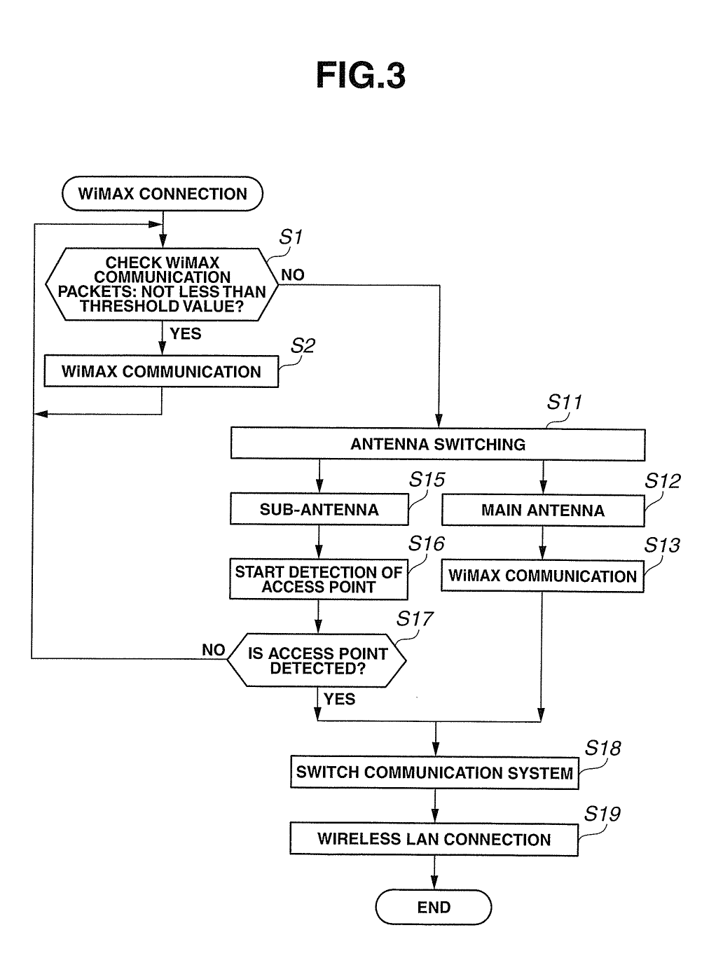

Operation of the embodiment with the above-described configuration will be described with reference to FIGS. 2A, 2B and 3. FIGS. 2A and 2B are timing charts for explaining a search instruction signal. FIG. 3 is a flow chart showing an operation flow of the embodiment.

Assume that communication by the WiMAX chip 18 is in progress under control of the control section 11. In this case, the power supply controlling section 26 supplies power to the WiMAX chip 18 of the wireless communication module 17 and stops supply of power to the wireless LAN chip 19, under control of the control section 11. The two antenna ports of the WiMAX chip 18 are connected to the antenna 24 and 25 by the antenna switching section 23. For example, the antenna 24 is used for transmission, and the antenna 25 is used for reception.

The WiMAX chip 18 supplies data to be transmitted from the control section 11 to the antenna 24 via the antenna switching section 23 to transmit the data and outputs received data obtained by receiving a high-frequency signal induced at the antenna 24 to the control section 11.

The number of data packets being communicated by the WiMAX chip 18 is measured by the communication data packet measuring section 14. A result of the measurement by the communication data packet measuring section 14 is given to the communication data packet determining section 15 and is compared with the predetermined threshold value.

FIG. 2A shows a change in the number of data packets being communicated by the WiMAX chip 18, with an abscissa representing time and an ordinate representing the number of communication data packets. Periods shown in FIG. 2A when the number of data packets is relatively small correspond to, for example, a period when the WiMAX chip 18 does not perform transmission and reception of various types of data and pieces of information for establishing and maintaining a communication channel with a base station are transmitted and received and a period when only reception of a broadcast message and the like from a base station is performed (the periods will be referred to as standby periods hereinafter). As shown in FIGS. 2A and 2B, the number of data packets communicated by the WiMAX chip 18 is less than the threshold value in such a standby period, and the number of data packets communicated by the WiMAX chip 18 is larger than the threshold value in a period other than a standby period, i.e., a period when various types of data are transmitted and received.

The communication data packet determining section 15 compares the number of data packets being communicated by the WiMAX chip 18 with the threshold value, thereby determining whether the WiMAX chip 18 is currently not performing transmission and reception of various types of data such as audio video data, i.e., whether the WiMAX chip 18 is in a standby period (step S1). The communication data packet determining section 15 outputs a result of the determination as to whether the WiMAX chip 18 is in a standby period to the command signal controlling section 16.

If the result of the determination by the communication data packet determining section 15 shows that transmission and reception of various types of data are currently being performed, instead of the standby period being performed the command signal controlling section 16 continues currently performed WiMAX communication (step S2).

Assume that the number of data packets being transmitted and received by the WiMAX chip 18 has become less than the threshold value. In this case, the command signal controlling section 16 generates a search instruction signal on the basis of the result of the determination (an on period in FIG. 2B). The search instruction signal is supplied to the WiMAX chip 18. The WiMAX chip 18 controls the wireless LAN MAC layer controlling section 22 in accordance with the search instruction signal so as to perform an access point search.

More specifically, the WiMAX chip 18 controls the antenna switching section 23 (step S11), sets the antenna 24 as a main antenna (step S12), and continues WiMAX communication using the main antenna. The WiMAX chip 18 sets the antenna 25 as a sub-antenna (step S15) and performs an access point search using the sub-antenna (step S16).

In other words, in the present embodiment, a wireless LAN access point search is performed only during a WiMAX communication standby period. Although a working frequency band of WiMAX communication and a working frequency band of wireless LAN communication conflict with each other, only pieces of information for establishing and maintaining a communication channel are transmitted and received during a standby period in WiMAX communication. An interference wave caused by a wireless LAN access point search has an extremely small adverse effect on WiMAX communication.

A wireless LAN access point search is performed by the wireless LAN MAC layer controlling section 22 in the WiMAX chip 18, and it is unnecessary to supply power to and activate the wireless LAN chip 19. Accordingly, an increase in power consumption of an entire system can be suppressed.

The two antennas 24 and 25 are separately assigned to be used for WiMAX communication and a wireless LAN search. This makes it possible to simultaneously perform WiMAX communication and a wireless LAN search and suppress mutual interference between WiMAX communication and a wireless LAN search.

The WiMAX chip 18 gives information on a search result obtained by an access point search to the control section 11. The control section 11 determines in step S17 whether an access point is detected by an access point search. If an access point is not detected, the flow returns to step S1 to repeat similar operations.

If an access point is detected, the control section 11 controls the communication system switching section 20 so as to switch the communication system. The power supply controlling section 26 supplies power to the wireless LAN chip 19 and stops supply of power to the WiMAX chip 18. The two antenna ports of the wireless LAN chip 19 are connected to the antennas 24 and 25 via the antenna switching section 23, and a wireless LAN connection is made to the access point. After that, data communication using a wireless LAN is performed by the wireless LAN chip 19.

As described above, the present embodiment can automate switching from WiMAX communication to wireless LAN communication, reduce an operational load of a user, and improve communication performance. Since a wireless LAN access point search is performed during a standby period when the number of data packets in WiMAX communication is sufficiently small, an adverse effect of an interference wave caused by an access point search on WiMAX communication can be suppressed. Additionally, a wireless LAN access point search is performed using a wireless LAN MAC layer controlling section provided in a WiMAX chip, supply of power to a wireless LAN chip is unnecessary, and an increase in power consumption can be suppressed. Moreover, antennas are separately prepared for WiMAX communication and an access point search, and an effect of mutual interference between WiMAX communication and an access point search can be suppressed.

Although the above embodiment has described an example in which two antennas are used, WiMAX communication and an access point search may be performed in a time-division manner using one antenna.

The present invention is not limited to the above-described embodiment, and in an implementation phase, various modifications can be made without departing from the scope of the present invention. The embodiment includes inventions in various phases, and various inventions can be extracted by appropriately combing a plurality of constituent features disclosed in the embodiment. For example, even if some of all constituent features disclosed in the embodiment are omitted, a configuration with the constituent features omitted can be extracted as an invention as long as the problems described in the BACKGROUND section can be solved, and the advantages described in the DETAILED DESCRIPTION can be achieved.

While a certain embodiment has been described, the embodiment has been presented by way of example only, and are not intended to limit the scope of the inventions. Indeed, the novel embodiment described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a wireless communication module including a first wireless communication section that supports a first wireless communication system and a second wireless communication section that supports a second wireless communication system having a working frequency band in conflict with a working frequency band of the first wireless communication system;
a traffic detecting section configured to calculate traffic of communication based on the first wireless communication system by the first wireless communication section;
a traffic determining section configured to determine whether the traffic is less than a predetermined threshold value; and
a control section configured to cause performance of an access point search for the second wireless communication system during a period when the traffic is less than the predetermined threshold value, on the basis of a result of the determination by the traffic determining section.

2. The information processing apparatus according to claim 1, wherein
the first wireless communication section has functions of a physical layer and a media access control layer of the second wireless communication system, and
the control section causes the first wireless communication section to perform the access point search for the second wireless communication system.

3. The information processing apparatus according to claim 1, further comprising:
a power supply controlling section configured to supply power only to any one of the first and second wireless communication sections.

4. The information processing apparatus according to claim 2, further comprising:
a power supply controlling section configured to supply power only to the first wireless communication section during a period when the access point search is performed.

5. The information processing apparatus according to claim 1, further comprising:
a first antenna for communication based on the first wireless communication system; and
a second antenna for the access point search for the second wireless communication system.

6. The information processing apparatus according to claim 2, further comprising:
two antennas, wherein
the first wireless communication section separately assigns an antenna for communication based on the first wireless communication system and an antenna for the access point search for the second wireless communication system to separate antennas of the two antennas.

7. The information processing apparatus according to claim 1, wherein
the control section switches from communication based on the first wireless communication system by the first wireless communication section to communication based on the second wireless communication system by the second wireless communication section if an access point is detected by the access point search for the second wireless communication system.

8. The information processing apparatus according to claim 2, wherein
the control section switches from communication based on the first wireless communication system by the first wireless communication section to communication based on the second wireless communication system by the second wireless communication section if an access point is detected by the access point search for the second wireless communication system.

9. The information processing apparatus according to claim 8, further comprising:
a power supply controlling section configured to supply power to the first wireless communication section during a period when the access point search for the second wireless communication system is performed and supply power to the second wireless communication section if an access point is detected by the access point search.

10. A communication controlling method for controlling communication by a wireless communication module including a first wireless communication system that supports a first wireless communication system and a second wireless communication section that supports a second wireless communication system having a working frequency band in conflict with a working frequency band of the first wireless communication system, comprising:
calculating traffic of communication based on the first wireless communication system by the first wireless communication section;
determining whether the traffic is less than a predetermined threshold value; and
causing performance of an access point search for the second wireless communication system during a period when the traffic is less than the predetermined threshold value, on the basis of a result of the determination.
